(19) United States
(12) Patent Application Publication
(10) Pub. No.: US 2005/0063362 A1
(43) Pub. Date: Mar. 24, 2005

(54) Combined voice and instrument data system

(76) Inventor: Andrew S. Poulsen, Fort Collins, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/671,924

(22) Filed: Sep. 24, 2003

(51) Int. Cl. H04L 12/56

(52) U.S. Cl. 370/352

(57) ABSTRACT

An instrument system. In representative embodiments, an instrument system includes an electronic instrument and a network interface module. The network interface module and the electronic instrument interchange instrument data via a first connector, the network interface module and a voice module interchange voice data via a second connector, and the network interface module and a network interchange combined voice and instrument data via a third connector. The voice data is in the form of an electronic signal. The network interface module combines instrument data and voice data into an outgoing data stream and separates the incoming data stream into its instrument data and voice data components.

### BACKGROUND

Voice-Over-IP is the name given to a system wherein voice, such as from voice telephone calls, is transported over a network, which could be for example the Internet, using standard Internet Protocol (IP) packets. Such systems provide the capability of carrying both data and the voice information using a single infrastructure. Development efforts directed to such systems, as well as protocols for use with them, have intensified over the past few years. In these systems, data-oriented switches can be used to switch data, including packetized voice.

Several advantages are inherent in such systems. In particular, the multiplexing of data and voice signals can result in a better utilization of bandwidth than is typically possible in voice only systems. The system provider thereby benefits by the more efficient utilization of his resources with an associated higher profit, while the customer stands to enjoy the benefits of the lower cost associated with this more efficient utilization of resources.

Current systems can utilize an audio-capable computer and/or a telephone connected to a public switched telephone network (PTSN) on either or both ends of the voice-over-IP system. In other words, the endpoints of a two party system could include (1) an audio-capable computer at the calling end of the system and an audio-capable computer at the called end of the system, (2) a telephone connected to a public switched telephone network at the calling end of the system and a telephone connected to a public switched telephone network at the called end of the system, (3) a telephone connected to a public switched telephone network at the calling end of the system and an audio-capable computer at the called end of the system, or (4) an audio-capable computer at the calling end of the system and a telephone connected to a public switched telephone network at the called end of the system.

Voice-Over-IP devices communicate with each other using signaling and voice-transporting protocols. Various standardization entities have specified standards for both signaling and voice-transporting protocols in order to insure the interoperability between products from different vendors.

### SUMMARY OF THE INVENTION

In representative embodiments an instrument system is described which includes an electronic instrument and a network interface module. The network interface module and the electronic instrument interchange electronic instrument data via a first connector, the network interface module and a voice module interchange voice data via a second connector, and the network interface module and a network interchange combined data (i.e., instrument data and voice data) via a third connector. The voice data has been converted to Internet protocol (IP) packets to allow it to be combined with the instrument data. The network interface module provides the means for combining instrument data and voice data into the outgoing data stream, and for separating the incoming data stream into its instrument data and voice data components. Additionally, the network interface module may also provide functionality to convert analog voice signals to digital voice data and/or to convert digital voice data into analog voice signals.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The accompanying drawings provide visual representations which will be used to more fully describe the invention and can be used by those skilled in the art to better understand it and its inherent advantages. In these drawings, like reference numerals identify corresponding elements.

FIG. 1 is a drawing of an instrument system as described in various representative embodiments consistent with the teachings of the invention.

FIG. 2 is a drawing of an instrument system connected to a remote diagnostic system as described in various representative embodiments consistent with the teachings of the invention.

FIG. 3 is a drawing of another instrument system as described in various representative embodiments consistent with the teachings of the invention.

FIG. 4 is a drawing of still another instrument system as described in various representative embodiments consistent with the teachings of the invention.

FIG. 5 is a drawing of yet another instrument system as described in various representative embodiments consistent with the teachings of the invention.

### DETAILED DESCRIPTION

Shown in the drawings for purposes of illustration is a Voice-Over-IP instrument system. Previously, close contact between remotely located diagnostic personnel and instrument systems has required separate data and voice paths. Systems disclosed herein provide this close contact between remotely located diagnostic personnel and electronic test instrument locations using a single network connection.

In the following detailed description and in the several figures of the drawings, like elements are identified with like reference numerals.

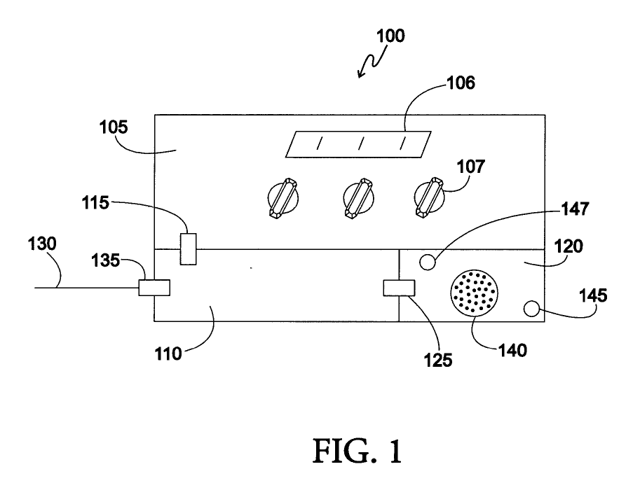

FIG. 1 is a drawing of an instrument system 100 as described in various representative embodiments consistent with the teachings of the invention. In FIG. 1, the instrument system 100 includes an electronic instrument 105 connected to a network interface module 110 via a first connector 115, also referred to herein as a data connector 115. The network interface module 110 and the electronic instrument 105 interchange instrument data via the first connector 115. The network interface module 110 and a voice module 120 interchange voice data via a second connector 125, also referred to herein as a voice connector 125, wherein the voice data is in the form of an electronic signal. Voice module 120 or network interface module 110 provides a data conversion function wherein the analog voice data is converted to digital information and compressed into IP packets, and also provides the reverse functionality wherein the incoming voice data IP packets are converted back into analog signals. The network interface module 110 combines instrument and voice data into the outgoing data stream, and separates the incoming data stream into its voice and instrument data components. The network interface module 110 and a network 130 interchange combined voice and instrument data via a third connector 135, also referred to herein as a network connector 135.

The electronic instrument 105, in various implementations, may comprise a display 106 for displaying data values and various control knobs 107 for controlling various setup and operational functions of the electronic instrument 105.

The voice module 120 comprises a transducer 140 which in the representative embodiment of FIG. 1 is a speaker 140. The voice module 120 further comprises an on/off switch 145. While not required, the voice module 120 is shown in FIG. 1 as physically attached to the electronic instrument 105. The network interface module 110 is also shown physically attached to the electronic instrument 105 and to the voice module 120. In an alternative embodiment, the voice module 120 may comprise two transducers 140, one acting as a speaker and a second acting as a microphone. In yet other embodiments, the on/off switch 145 is omitted.

A call button 147 could be provided wherein an operator or engineer at the instrument location could press that button 147 which could be located on the instrument chassis, thereby automatically connecting to a support location for support help for the instrument 105. The system 100 is easily integrated with remote on-line support for the instrument 105 which enables remote diagnostics of the instrument 105.

In typical applications, the network 130 is a Local Area Network (LAN) 130 or a Wide Area Network (WAN) 130 such as the Internet 130.

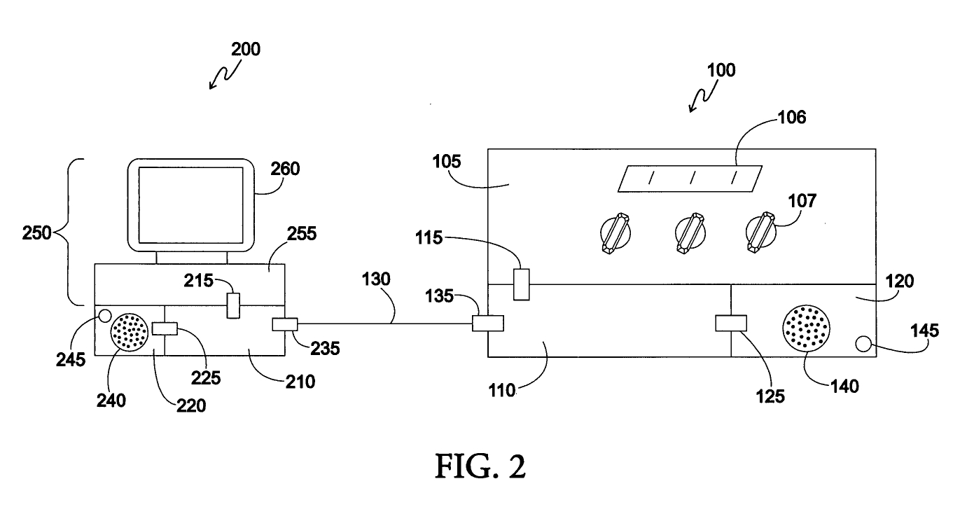

FIG. 2 is a drawing of the instrument system 100 connected to a remote diagnostic system 200 as described in various representative embodiments consistent with the teachings of the invention. In the representative embodiment of FIG. 2, instrument data obtained by the electronic instrument 105 is transferred to the network interface module 110 at the first connector 115. An operator at the same location as the electronic instrument 105 could be in communication with another individual located remote from the operator's location by, for example, speaking into and/or listening to the speaker 140 in voice module 120.

In a representative situation, the voice module 120 is a telephone 120 with a speaker 140 (i.e., a speaker phone 120) built into the instrument chassis. The operator speaks into the speaker 140 which is a transducer 140 that transforms his voice into an electronic signal that may be amplified by the voice module 120. This electronic signal is referred to herein as voice data. Additionally, the voice data may be converted into digital form and compressed into IP packets by voice module 120. The voice data is transferred to the network interface module 110 at the second connector 125. If the voice data is not already in the form of IP packets, network interface module 110 converts the voice data into IP packets, as mentioned above. The network interface module 110 then combines the instrument data from the electronic instrument 105 with voice data in IP format from the voice module 120 to form a combined data stream which is typically in a packetized format. The combined data is then transferred to the network 130 via third connector 135.

First connector 115 could be any electronic connector appropriate to the particular application. The first connector 115 could be, for example, a wire, a feed-thru, a plug and receptacle, a high-frequency connector, a fiber optics interface, or the like. Second connector 125 could also be any electronic connector appropriate to the particular application. The second connector 125 could be, for example, a wire, a feed-thru, a plug and receptacle, a standard telephone plug and/or receptacle, or the like. Third connector 135 could be any electronic connector appropriate to the particular application. The third connector 135 could be, for example, a wire, a feed-thru, a plug and receptacle, a high-frequency connector, an Ethernet connector, a fiber optics interface, or the like. The third connector 135 could also provide a wireless connection to another network-enabled device connected to the network 130.

The combined data transferred to the network 130 via third connector 135 by the network interface module 110 is transported by the network 130 to a remote system 200 which in the representative embodiment of FIG. 2 is shown as a computer system 200. The remote system 200 could comprise additional network connector 235 which may or may not be of the same type as found on the network interface module 110 which is attached to the electronic instrument 105. Combined instrument and voice data is transported from the network 130 to additional network interface module 210 via additional network connector 235. The network interface module 210 of the remote system 200 separates the combined voice and instrument data received from the network 130 into voice data and instrument data.

The instrument data is transferred from the additional network interface module 210 via additional data connector 215 to a remote data analysis instrument 250 which is shown in FIG. 2 as a computer central processing unit (CPU) 255 with a computer monitor 260. However, the data analysis instrument 250 could also comprise any other electronic system appropriate to the particular application.

The voice data may be decoded and converted to an analog signal by the additional network interface module 210. The voice data is transferred from the additional network interface module 210 via additional voice connector 225 to additional voice module 220 located at the remote system 200. If the voice data has not yet been decoded and converted into an analog signal, additional voice module 220 will provide this function. The additional voice module 220 located at the remote system 200 comprises a transducer 240, wherein the transducer 240 transforms the electronic voice data received from additional network interface module 210 into sounds replicating the human voice. The additional voice module 220 further comprises an on/off switch 245. While not required, the additional voice module 220 is shown in FIG. 2 as physically attached to the remote data analysis instrument 250. The additional network interface module 210 is also shown physically attached to the remote data analysis electronic instrument 250 and to the additional voice module 220. In the representative embodiment of FIG. 2, the transducer 240 is shown as speaker 240. Thereby, the operator located at the electronic instrument 105 can easily convey a spoken message to an individual located at the remote system 200. At the same time and using the same network connections, data from the electronic instrument 105 is transferred to the remote data analysis instrument 250. In an alternative embodiment, the additional voice module 220 may comprise two transducers 240, one acting as a speaker and a second acting as a microphone. In still other embodiments, the on/off switch 245 is omitted.

The additional data connector 215 could be any electronic connector appropriate to the particular application. The additional data connector 215 could be, for example, a wire, a feed-thru, a plug and receptacle, a high-frequency connector, a fiber optics interface, or the like. Additional voice connector 225 could also be any electronic connector appropriate to the particular application. The additional voice connector 225 could be, for example, a wire, a feed-thru, a plug and receptacle, a standard telephone plug and/or receptacle, or the like. Additional network connector 235 could be any electronic connector appropriate to the particular application. The additional network connector 235 could be, for example, a wire, a feed-thru, a plug and receptacle, a high-frequency connector, an Ethernet connector, a fiber optics interface, or the like. The additional network connector 235 could also provide a wireless connection to another network-enabled device connected to the network 130.

In a manner similar to the above and in a representative situation, the additional voice module 220 is a telephone 220 with a speaker 240 (i.e., a speaker phone 220) built into the chassis of the remote data analysis instrument 250. Personnel at, for example, a diagnostic center can speak into the speaker 240, which is a transducer 240 that transforms that individual's voice into an electronic signal that may be amplified by the additional voice module 220. Additionally, the voice data may be converted into digital form and compressed into IP packets by the additional voice module 220. The voice data is transferred to the additional network interface module 210 at the additional voice connector 225. If the voice data is not already in the form of IP packets, additional network interface module 210 converts the voice data into IP packets as mentioned above. The additional network interface module 210 then combines the instrument data from the remote data analysis instrument 250 with voice data in IP format from the additional voice module 220 to form a combined data stream which is typically in a packetized format. The combined data is then transferred to the network 130 via additional network connector 235.

The combined data transferred to the network 130 by the additional network interface module 210 via additional network connector 235 is transported by the network 130 to the instrument system 100. The combined data is transferred from the network 130 to the network interface module 110 via the third connector 135. The network interface module 110 of the instrument system 100 separates the combined data received from the network 130 into voice data and instrument data.

The instrument data is transferred via first connector 115 to the electronic instrument 105. The voice data may be decoded and converted to an analog signal by the network interface module 110. The voice data is transferred via second connector 125 to voice module 120 located at the instrument system 100. If the voice data has not yet been decoded and converted into an analog signal, voice module 120 will provide this function. As previously stated, the voice module 120 located at the instrument system 100 comprises at lease one transducer 140, wherein the transducer 140 transforms the electronic voice data received from network interface module 110 into sounds replicating the human voice. In the representative embodiment of FIG. 2, the transducer 140 is shown as speaker 140. Thereby, the operator located at the electronic instrument 105 can easily receive a spoken message from an individual located at the remote system 200. At the same time and using the same network connections, data from the remote data analysis instrument 250 can be transferred to the electronic instrument 105.

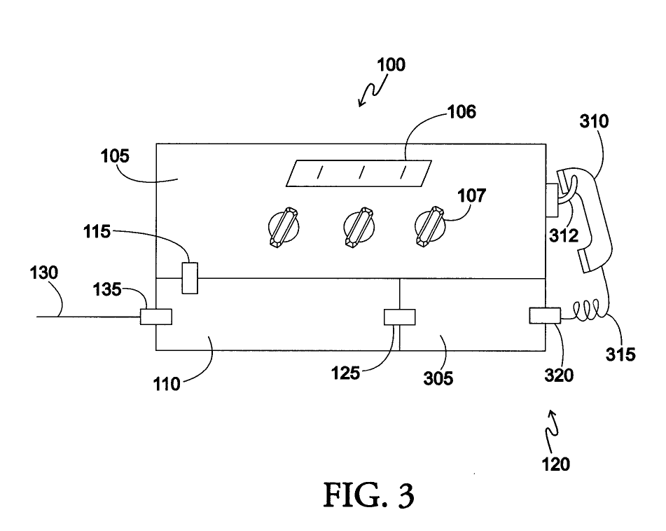

FIG. 3 is a drawing of another instrument system 100 as described in various representative embodiments consistent with the teachings of the invention. In FIG. 3, the voice module 120 is shown as separated into various components comprising voice-module electronics 305 and a handset 310, wherein the handset 310 is typically connected to the voice-module electronics 305 via a handset cord 315 which could be, for example, plugged into a handset jack 320 attached to the voice-module electronics 305. The handset 310 may also have a wireless connection, i.e., radio frequency (RF) or infrared (IR) to the voice-module electronics 305. A hook 312 attached to the instrument chassis may be used for storing the handset 310. The hook 312 may also perform the function of the on/off switch 145 as is common practice in the telephone industry.

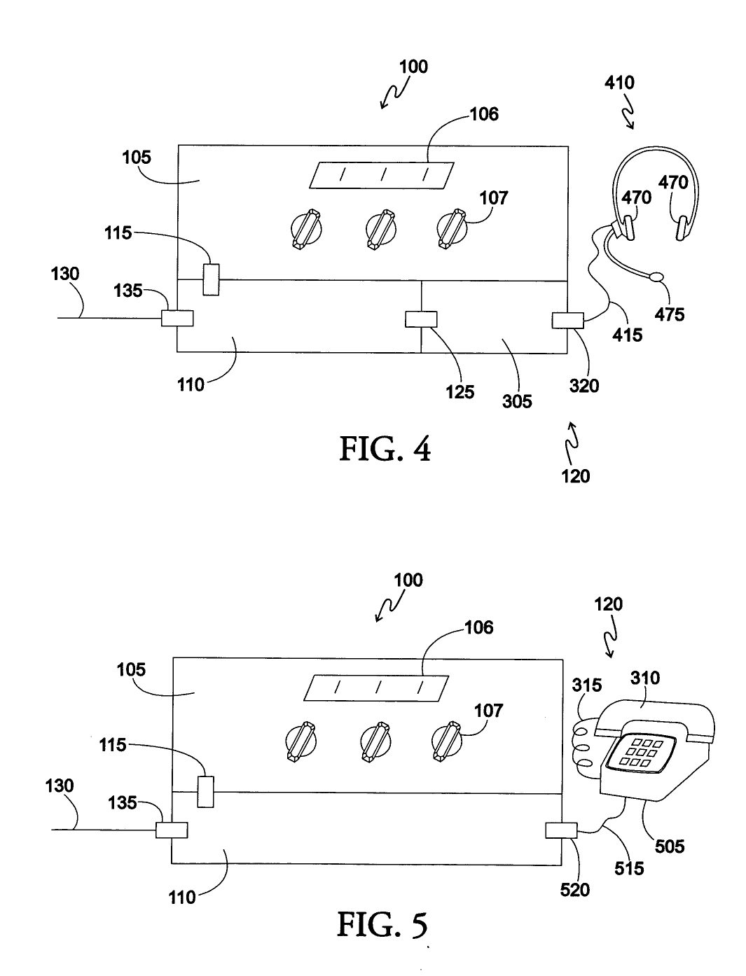

FIG. 4 is a drawing of still another instrument system 100 as described in various representative embodiments consistent with the teachings of the invention. In FIG. 4, the voice module 120 is shown as separated into various components comprising voice-module electronics 305 and a headset 410, wherein the headset 410 is typically connected to the voice-module electronics 305 via a headset cord 415 which could be, for example, plugged into the handset jack 320 attached to the voice-module electronics 305. The headset 410 may also have a wireless connection, i.e., radio frequency (RF) or infrared (IR) to the voice-module electronics 305. The headset 410 would typically comprise one or two earphones 470 and a microphone 475.

FIG. 5 is a drawing of yet another instrument system 100 as described in various representative embodiments consistent with the teachings of the invention. In FIG. 5, the voice module 120 is shown as physically separated from the electronic instrument 105 and the network interface module 110. The voice module 120 is further shown as a conventional telephone 120. Various components of the telephone are shown, as for example, handset 310 connected to the telephone base 505. The telephone base 505 would house the voice-module electronics 305 indicated in Figure FIGS. 3 and 4. Handset 310 connects to the voice-module electronics 305 via handset cord 315 and the voice-module electronics 305 connects to the network interface module 110 via telephone cord 515 which could be, for example, plugged into a telephone jack 520 attached to the voice-module electronics 305.

As is the case in many products involving data-processing, certain elements of the above described embodiments may be implemented as a combination of hardware and software components. Moreover, certain elements of the functionality required for using these embodiments may be embodied in computer-readable media to be used in programming an information-processing apparatus (e.g., a personal computer comprising the elements shown in FIG. 2) to perform as described with respect to the above.

The term “computer readable media” is broadly defined herein to include any kind of computer memory such as, but not limited to, floppy disks, conventional hard disks, DVD's, CD-ROM's, Flash ROM's, nonvolatile ROM, Flash RAM, other nonvolatile RAM, and RAM.

The display of the computer monitor 260 shown in FIG. 2 may be monochrome or color, and a pointing device (not shown) such as pen, mouse, track point or a touch screen that is suitable for cursor manipulation may be used.

The computer central processing unit 255 can be capable of running any commercially available operating system such as DOS, any of a variety of Windows operating systems including, for example, Windows 2000 or XP, Unix (including Linux), real-time operating systems such as VxWorks, or any other suitable operating system. The operating system can include support of a spreadsheet, database, or other specialized data collection software.

The total real cost of instrument ownership should include the costs of instrument downtime due to instrument malfunction, instrumentation updating, and other reasons, as well as cost of service contracts and calls. Such costs can be reduced by the effective use of remote support of the electronic instruments. Remote support often includes the physical presence of an operator and/or engineer. The engineer may be employed by the company owning the instrument, by the manufacturer of the instrument, or by a third party. Often these individuals need to speak with an individual in a remotely located instrument customer support facility.

In various instrument environments, as for example, the production floor of a manufacturing facility, telephones or even telephone outlets may not be conveniently located with respect to the instrument. In such situations, cell phones would be a possible choice. However, it is possible that due to the nature of the manufacturer's facility, cell phones may not be allowed or due to the location of the cell phone provider's antennas such use is not possible. Further, long distance calls can become expensive for the long durations that may be required to solve a given instrument problem. Representative embodiments of the integrated voice-over-IP instrument system disclosed herein provide a convenient, cost effective means for voice and data communication between an individual located at an electronic instrument and a remotely located monitoring/troubleshooting facility. All that is needed at the instrument location is a connection to a network, as for example an Ethernet network. Tie-ins to such local area networks which are in turn connected to a Wide-Area Network (such as the internet) are becoming more and more common.

A call button 147 via additional network connector 235 (see FIG. 1) could be provided wherein the operator or engineer at the instrument location could press that button which could be conveniently located on the instrument, thereby automatically connecting to a support location in case support help is needed for the instrument. This interface could also be provided through a “virtual button”, i.e., an item on the instrument display that the user could select, such as with a mouse-click or other user action. The system is easily integrated with remote on-line support for the instrument which enables remote diagnostics of the instrument.

Voice-over-IP requires only a small increase in bandwidth over the standard data transmissions required for diagnostics of a problem.

While the present invention has been described in detail in relation to preferred embodiments thereof, the described embodiments have been presented by way of example and not by way of limitation. It will be understood by those skilled in the art that various changes may be made in the form and details of the described embodiments resulting in equivalent embodiments that remain within the scope of the appended claims.

1. An instrument system, comprising:
an electronic instrument; and
a network interface module, wherein the network interface module and the electronic instrument interchange instrument data via a first connector, wherein the network interface module and a voice module interchange voice data via a second connector, wherein the voice data is in the form of an electronic signal, wherein the network interface module and a network interchange combined voice and instrument data via a third connector, and wherein the network interface module effects transposition between combined voice and instrument data and separated instrument data and voice data.

2. The instrument system as recited in claim 1, wherein interchange of instrument data between the network interface module and the electronic instrument comprises the reception of instrument data from the electronic instrument by the network interface module.

3. The instrument system as recited in claim 1, wherein interchange of instrument data between the network interface module and the electronic instrument comprises the transmission of instrument data from the network interface module to the electronic instrument.

4. The instrument system as recited in claim 1, wherein interchange of voice data between the network interface module and the voice module comprises the reception of voice data from the voice module by the network interface module.

5. The instrument system as recited in claim 4, further comprising the voice module, wherein the voice module comprises a transducer, wherein the transducer transforms the human voice into electronic voice data.

6. The instrument system as recited in claim 1, wherein interchange of voice data between the network interface module and the voice module comprises the transmission of voice data from the network interface module to the voice module.

7. The instrument system as recited in claim 6, further comprising the voice module, wherein the voice module comprises a transducer, wherein the transducer transforms electronic voice data into sounds replicating the human voice.

8. The instrument system as recited in claim 1, wherein interchange of combined voice and instrument data between the network interface module and the network comprises the reception of a data stream comprising combined instrument data and voice-over-IP data from the network by the network interface module and wherein the network interface module transposes the combined instrument data and voice-over-IP data into separated instrument data and voice data.

9. The instrument system as recited in claim 1, wherein the network interface module transposes separated instrument data and voice data into combined instrument and voice-over-IP data and wherein interchange of combined voice and instrument data between the network interface module and the network comprises the transmission of a data stream comprising the combined instrument and voice-over-IP data from the network interface module to the network.

10. The instrument system as recited in claim 1, further comprising the voice module.

11. The instrument system as recited in claim 10, wherein the voice module is physically attached to the electronic instrument.

12. The instrument system as recited in claim 11, wherein the transducer is a speaker.

13. The instrument system as recited in claim 10, wherein the voice module is a telephone.

14. The instrument system as recited in claim 10, wherein the voice module comprises a handset, wherein the handset is used for communication with an operator.

15. The instrument system as recited in claim 10, wherein the voice module comprises a headset, wherein the headset is used for communication with an operator.

16. The instrument system as recited in claim 10, wherein the voice module comprises a speaker, wherein the speaker is used for communication with an operator.

17. The instrument system as recited in claim 1, wherein the network interface module is physically attached to the electronic instrument.

18. The instrument system as recited in claim 1, wherein the network is an local area network (LAN).

19. The instrument system as recited in claim 1, wherein the network is the internet.

20. The instrument system as recited in claim 1, wherein the network is a Wide-Area-Network.

21. The instrument system as recited in claim 1, wherein the system enables communication between the electronic instrument and a remote system.

22. The instrument system as recited in claim 1, wherein the system enables communication between an operator located with the electronic instrument and another individual located remote from the operator's location.

23. The instrument system as recited in claim 21, wherein diagnostic instrument data from the electronic instrument is transmitted to a remote data analysis instrument.

24. The instrument system as recited in claim 21, wherein the third connector provides a wireless connection to the network.
